(19) United States
(12) Patent Application Publication
(10) Pub. No.: US 2025/0063138 A1
(43) Pub. Date: Feb. 20, 2025

(54) APPARATUS AND METHOD FOR CONTROLLING AN ONLINE MEETING

(71) Applicant: CANON U.S.A., INC., MELVILLE, NY (US)

(72) Inventors: Stephanie Ann Suzuki, Irvine, CA (US); Hung Khei Huang, Irvine, CA (US); Don Francis Purpura, Yorba Linda, CA (US)

(21) Appl. No.: 18/721,535

(22) PCT Filed: Dec. 16, 2022
(86) PCT No.: PCT/US2022/081860

§ 371 Date: Jun. 18, 2024

Related U.S. Application Data
(60) Provisional application No. 63/292,271, filed on Dec. 21, 2021.

(51) Int. Cl. H04N 7/15; G06T 5/80; G06V 10/25; G06V 40/16; G06V 40/20; H04N 7/14; H04N 23/69

(52) U.S. Cl. CPC H04N 7/152; G06T 5/80; G06V 10/25; G06V 40/161; G06V 40/28; H04N 7/147; H04N 23/69; G06T 2207/20132

(57) ABSTRACT

An apparatus and control method for controlling an online meeting is provided for receiving, from a camera, a captured video of the meeting room, transmitting, via a first server, the captured video of the meeting room to an online meeting client, specifying an ROI (Region Of Interest) in the meeting room, controlling an optical zoom magnification of the camera for capturing a still image of the ROI in the meeting room, and transmitting, via a second server that is different from the first server processing the captured video of the meeting room, the still image that the camera captures after the control for the optical zoom magnification to the online meeting client.

### CROSS REFERENCE TO RELATED APPLICATIONS

This application claims priority from U.S. Provisional Patent Application Ser. No. 63/292,271 filed on Dec. 21, 2021, the entirety of which is incorporated herein by reference.

### FIELD OF THE DISCLOSURE

The present disclosure relates to a system and method for controlling an online meeting.

### BACKGROUND

Online meeting services such as Teams, Zoom, and Skype are known. Typically, during an online meeting using such services, a camera implemented in a laptop captures and provides a video to the other attendees.

In the conventional meeting service, it may be easy to see a face or a facial expression of each attendee who is located in front of a camera implemented in a laptop but it may not be easy to see the other information such as a whiteboard in a meeting room, ROIs specified in a meeting room, a face of a presenter who is not facing a laptop, or the like.

### SUMMARY

An apparatus and control method for controlling an online meeting is provided for receiving, from a camera, a captured video of the meeting room, transmitting, via a first server, the captured video of the meeting room to an online meeting client, specifying an ROI (Region Of Interest) in the meeting room, controlling an optical zoom magnification of the camera for capturing a still image of the ROI in the meeting room, and transmitting, via a second server that is different from the first server processing the captured video of the meeting room, the still image that the camera captures after the control for the optical zoom magnification to the online meeting client. As a result, in an online meeting, information other than attendees' face located in front of a PC will be improved in visibility.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates the system architecture according to the present disclosure

FIG. 2 depicts a flowchart illustrating an operation of the control apparatus according to the present disclosure.

FIG. 3 depicts a flowchart illustrating one or more processes shown in FIG. 2.

FIG. 4 illustrates name and position information.

FIG. 5 is a flowchart illustrating one or more processes shown in FIG. 2.

FIG. 6 is a flowchart illustrating one or more processes shown in FIG. 2.

FIG. 7 illustrates a display screen for presenter switching.

FIG. 8A illustrates a first presenter switching process.

FIG. 8B illustrates a second presenter switching process.

FIG. 9A illustrates a display screen generated by the control apparatus.

FIG. 9B illustrates a display screen generated by the control apparatus.

FIG. 10A illustrates a display screen generated by the control apparatus.

FIG. 10B illustrates a display screen generated by the control apparatus.

FIG. 11 illustrates a display screen generated by the control apparatus and provided to one or more client computers.

FIG. 12 illustrates a display screen generated by the control apparatus and provided to one or more client computers.

FIG. 13 illustrates a display screen generated by the control apparatus and provided to one or more client computers.

FIG. 14 illustrates a display screen generated by the control apparatus and provided to one or more client computers.

FIG. 15 illustrates a display screen generated by the control apparatus and provided to one or more client computers.

FIG. 16 illustrates a display screen generated by the control apparatus and provided to one or more client computers.

FIG. 17 illustrates information regarding still images.

FIG. 18 is a flowchart illustrating an operation of Client computers 106 and 107.

FIG. 19 illustrates exemplary hardware configuration.

FIG. 20 illustrates hand gestures for capturing information.

FIG. 21 is a flow chart illustrating hang gesture capture processing.

FIG. 22 is a flow chart illustrating hang gesture capture processing.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

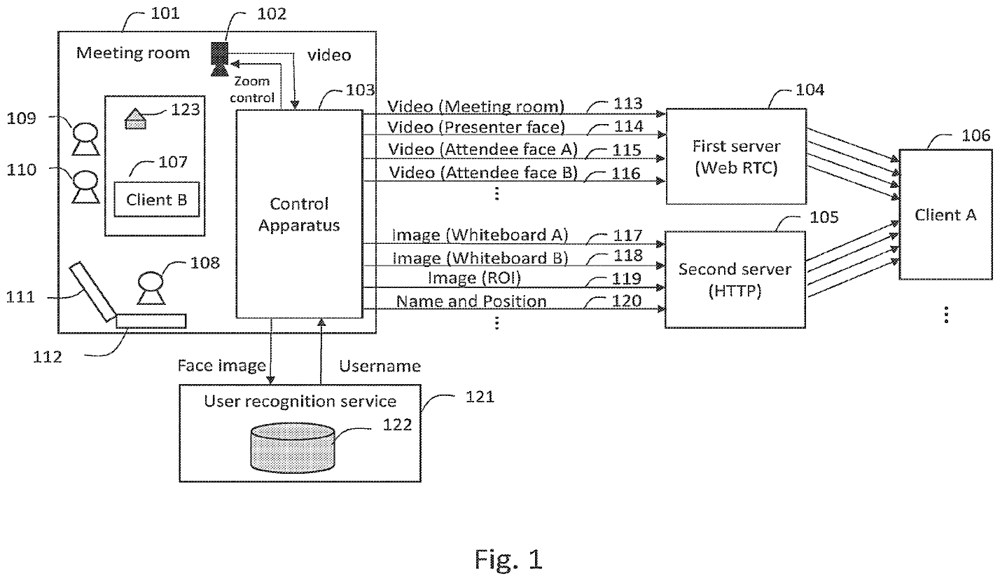

FIG. 1 illustrates a system architecture according to an exemplary embodiment. The system includes a camera 102, a control apparatus 103, a first server 104, a second server 105, a client computer A 106, a client computer B 107 and a user recognition service 121. In this embodiment, the camera 102, the control apparatus 103 and the client computer B 107 may be located in a meeting room 101 but this is not seen to be limiting. FIG. 1 illustrates that each of the camera 102, the control apparatus 103 and the user recognition service 121 is implemented in a different device shown in FIG. 1 but it's not seen to be limiting. For example, the control apparatus 103 may be able to work as the user recognition service 121.

In an exemplary embodiment, the client computer A 106 and the client computer B 107 executes the same computer programs for an online meeting to work as the online meeting clients. However, the client computer A 106 and the client computer B 107 are described by a different name according to whether the computer is located in the meeting room 101 or not, for explanation purpose.

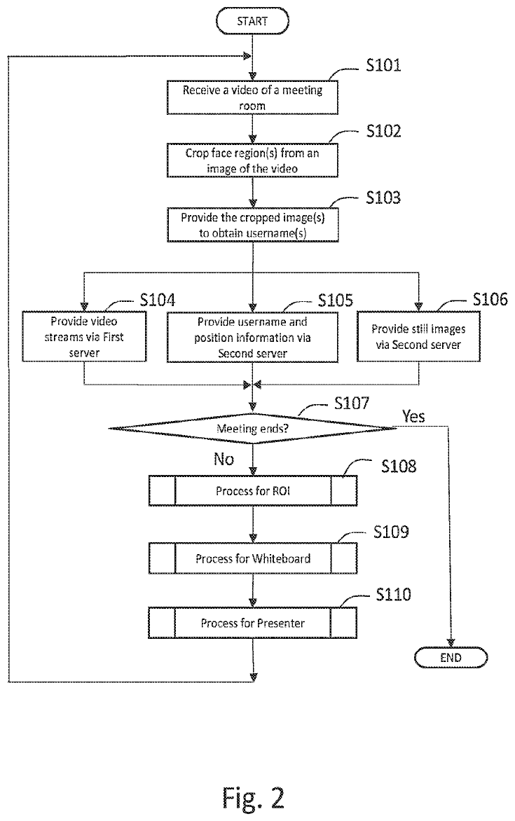

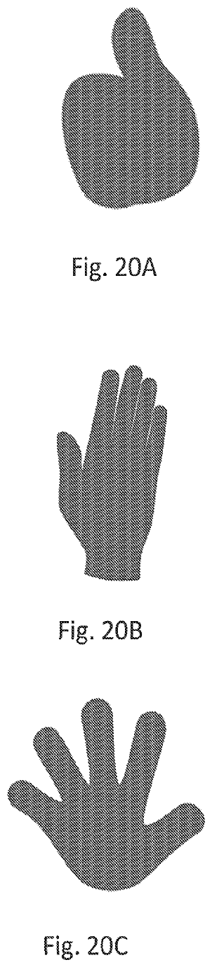

FIG. 2 is a flowchart illustrating an operation of the control apparatus 103 according to an exemplary embodiment. The operation of the control apparatus 103 according to an exemplary embodiment will be described in detail below with reference to FIG. 1 and FIG. 2. The operation described with reference to FIG. 2 will be started in response to a trigger event that the control apparatus 103 detects a predetermined gesture for starting an online meeting from a video captured by the camera 102. In an exemplary embodiment, when the control apparatus 103 keeps detecting a thumbs-up gesture (see FIG. 20A) within a predetermined range from a face region for a predetermined time period (e.g. 3 seconds), the control apparatus 103 outputs a predetermined sound A to notify of the user that the control apparatus 103 detects the hand gesture for starting an online meeting, and if the hand gesture further keeps a predetermined time period (e.g. 2 seconds), the control apparatus 103 outputs a predetermined sound B to notify of the user that the control apparatus 103 starts an online meeting as per the hand gesture, then flow proceeds to S101. In another embodiment, in addition to, or instead of the sounds, the control apparatus 103 may cause a visual indicator to be operated. This may include, for example, sending a control signal to a visual indicator present on the camera capturing the images such that the visual indicator is caused to flash in a certain pattern or in different colors thereby unobtrusively indicating, to the user, that the gesture has been detected.

However, this is not seen to be limiting. For example, the operation reference to FIG. 2 may be started by other hand gesture, voice controls, keyboard operations or mouse operations by a user of the control apparatus 103. Also, each of the steps described with reference to FIG. 2 is realized by one or more processors (CPU 501) of the control apparatus 103 reading and executing a pre-determined program stored in a memory (ROM 503).

In S101, the control apparatus 103 receives, from the camera 102, a captured video of the meeting room 101. The camera 102 is set in the Meeting room 101, performs real-time image capturing in the Meeting room 101, and transmits the captured video to the control apparatus 103.

In S102, the control apparatus 103 performs detection process for detecting one or more face regions of respective users from the captured video. More specifically, the control apparatus 103 identifies one or more video frames from among a plurality of video frames constituting the captured video, and perform face detection process on the identified video frame(s). As illustrated in FIG. 1, there are three people (108, 109 and 110) in the meeting room 101, so three face regions are detected during the processing performed in S102. The control apparatus 103 crops the three face regions from the identified video frame(s). Each of these three cropped face regions may be used as respective video input feeds that may be selectable and viewable by remote users as will be discussed below. While the detection processing is described as being performed by the control apparatus, the detection processing can be performed directly by the camera 102. In so doing, the in-camera detection may provide location information identifying pixel areas in the image being captured that contain a detected face and the control apparatus 103 may use this information as discussed below.

In S103, the control apparatus 103 transmits the three cropped face regions (face images) to the user recognition service 121 to obtain Usernames corresponding to the three face regions. The user recognition service 121 comprises the database 122 which stores Facial data and Username information associated with respective facial data. The user recognition service 121 is able to compare the face images received from the control apparatus 103 with Facial data in the database 122 to identify the Username corresponding to the face region detected from the video. The identified username is provided from the user recognition service 121 to the control apparatus 103.

In S104, the control apparatus 103 transmits, via the first server 104, to the client computers 106 and 107, (i) a video 113 of the meeting room 101, (ii) a video 114 of the face region of the person 108 which is cropped from the video of the meeting room 101, (iii) a video 115 of the face region of the person 109 which is cropped from the video of the meeting room 101 and (iv) a video 116 of the face region of the person 110 which is cropped from the video of the meeting room 101. The control apparatus 103 communicates with the first server 104 based on a first communication protocol (e.g. WebRTC) on which a bit rate of a media content is changed according to an available bandwidth of a communication path between the control apparatus 103 and the first server 104.

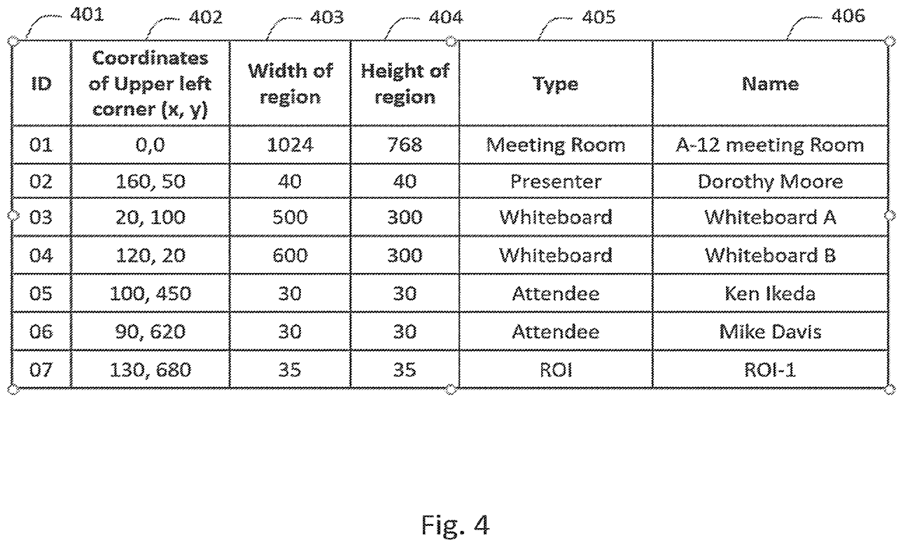

In S105, the control apparatus 103 transmits, via the second server 105, to the client computers 106 and 107, the name and position information 120 which contains name and position of each region. The control apparatus 103 communicates with the second server 105 based on a second communication protocol (e.g. HTTP) on which a bit rate of a media content is not changed according to an available bandwidth of a communication path between the control apparatus 103 and the second server 105. FIG. 4 illustrates an example of the name and position information 120 which is provided by the control apparatus 103 to the client computers 106 and 107.

As shown in FIG. 4, the name and position information 120 contains ID 401, the coordinates of upper left corner 402, Width of region 403, Height of region 404, Type 405 and Name 406. The control apparatus 103 assigns the ID 401 to each video stream. Also the control apparatus 103 specifies the coordinates of upper left corner 402, the width of region 403 and the height of region 404 of each region based on face detection process, presenter designation process, ROI designation process, whiteboard detection process and the like. More details of these process will be described later.

The control apparatus 103 may also specify the type 405 of each video stream based on face detection process, presenter designation process, ROI designation process, whiteboard detection process and the like. For example, if the face detection process detects a region, the type 405 of the region may be “Attendee”, and if the whiteboard detection process detects a region, the type 405 of the region may be “Whiteboard”. The control apparatus 103 obtains the Name 406 of “Attendee” from the user recognition service 121 which performs the user recognition process using the database 122 as described above. The name 406 of “Whiteboard” is determined according to the detection or designation order. For example, the name 406 of a whiteboard that is detected (or designated) first may be “Whiteboard A” and the name 406 of a whiteboard that is detected (or designated) may be “Whiteboard B”.

The name 406 of “ROI” is determined according to the detection or designation order. For example, the name 406 of an ROI firstly detected or designated may be “ROI-1” and the name 406 of an ROI that is secondly detected or designated may be “ROI-2”. If the number of ROI is limited to One, and a new ROI is detected or designated while an ROI is already existing as shown in ID=07 in FIG. 4, then the information 402, 403 and 404 of the row whose ID=7 may be updated based on the newly detected or designated ROI region instead of adding a new row for “ROI-2”. In other words, the number of Whiteboards and/or ROIs may be limited to a predetermined number, and after reaching to the predetermined number, the position information 402, 403 and 404 of the oldest one may be updated based on the newly detected or designated region.

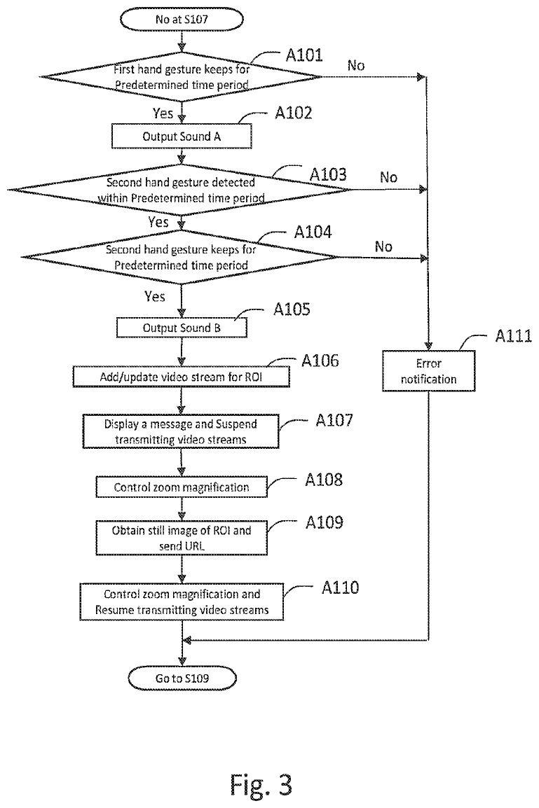

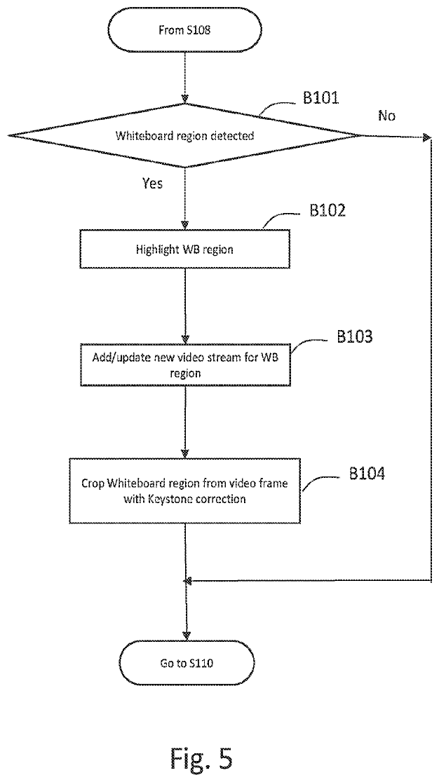

Returning to FIG. 2, in S106, the control apparatus 103 transmits, via the second server 105, to the client computers 106 and 107, (i) a still image 117 of the Whiteboard A 111 which is cropped from a video frame of the meeting room 101, (ii) a still image 118 of the Whiteboard B 112 which is cropped from a video frame of the meeting room 101 and (iii) a still image 119 of the ROI (Region Of Interest) which is cropped from a video frame of the meeting room 101. The detailed explanation of the process for whiteboard is provided later with reference to FIG. 5, and the detailed explanation of the process for ROI is provided later with reference to FIG. 3.

In S107, the control apparatus 103 determines whether the online meeting is closed. The online meeting will be closed in response to a trigger event that the control apparatus 103 detects a predetermined gesture for finishing an online meeting from a video captured by the camera 102. In the present exemplary embodiment, when the control apparatus 103 keeps detecting a hand gesture showing a palm (see FIG. 20B) within a predetermined range from a face region for a predetermined time period (e.g. 3 seconds), the control apparatus 103 outputs a predetermined sound C to notify of the user that the control apparatus 103 detects the hand gesture for finishing the online meeting, and if the hand gesture further keeps a predetermined time period (e.g. 2 seconds), the control apparatus 103 outputs a predetermined sound D to notify of the user that the control apparatus 103 closes the online meeting as per the hand gesture, then flow proceeds to END. If the online meeting is not over, flow proceeds to S108. However, this is not seen to be limiting. For example, the online meeting may be closed by other hand gestures, voice controls, keyboard operations or mouse operations by a user of the control apparatus 103.

In S108, the control apparatus 103 performs process regarding ROI. The detailed explanation of this ROI process will be provided later with reference to FIG. 3.

In S109, the control apparatus 103 performs process regarding Whiteboards. The detailed explanation of this Whiteboard process will be provided later with reference to FIG. 5.

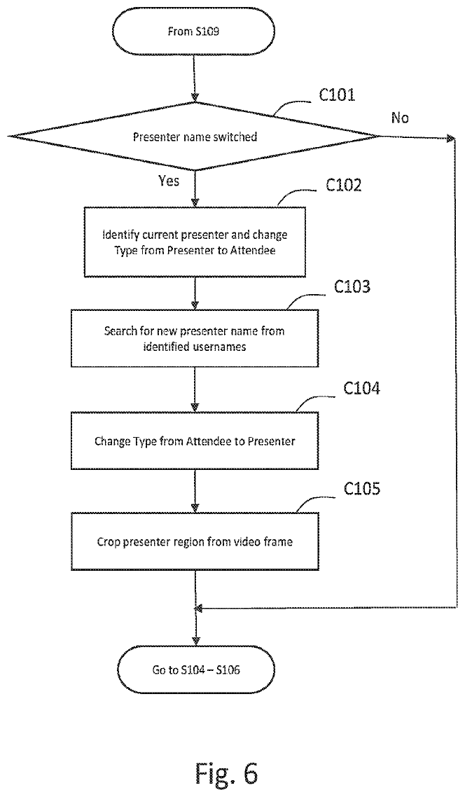

In S110, the control apparatus 103 performs process regarding Presenter. The detailed explanation of this Presenter process will be provided later with reference to FIG. 6. After completion of S110, flow returns to S101.

Each of the client computers 106 and 107 is able to display an online meeting window.

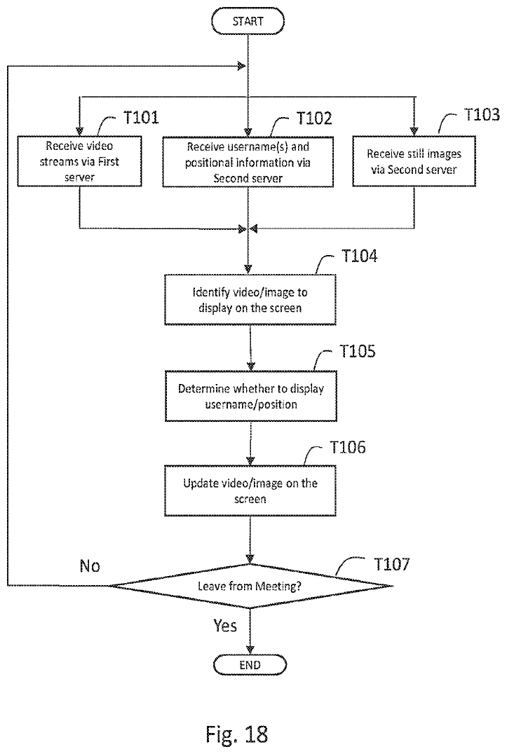

FIG. 18 is a flowchart illustrating an operation of the client computer 106 according to an exemplary embodiment. The operation described with reference to FIG. 18 will be started in response to a trigger event that the client computer 106 detects a predetermined user operation for joining the online meeting. In the present exemplary embodiment, the client computer 106 may detect that the user clicks a join button on its display screen, and then flow proceeds to T101-T103. The below explanation with reference to FIG. 18 will mainly focus on the operations of the client computer 106 but the client computer 107 is able to perform the same steps as the client computer 106.

In T101, the client computer 106 receives, via the first server 104, from the control apparatus 103, (i) a video 113 of the meeting room 101, (ii) a video 114 of the face region of the person 108 which is cropped from the video of the meeting room 101, (iii) a video 115 of the face region of the person 109 which is cropped from the video of the meeting room 101 and (iv) a video 116 of the face region of the person 110 which is cropped from the video of the meeting room 101.

In T102, the client computer 106 receives, via the second server 105, from the control apparatus 103, the name and position information 120 which contains name and position of each region. FIG. 4 illustrates an example of the name and position information which is provided by the control apparatus 103 to the client computers 106 in T102.

In T103, the client computer 106 receives, via the second server 105, from the control apparatus 103, (i) a still image 117 of the Whiteboard A 111 which is cropped by the control apparatus 103 from a video frame of the meeting room 101, (ii) a still image 118 of the

Whiteboard B 112 which is cropped by the control apparatus 103 from a video frame of the meeting room 101 and (iii) a still image 119 of the ROI (Region Of Interest) which is cropped by the control apparatus 103 from a video frame of the meeting room 101.

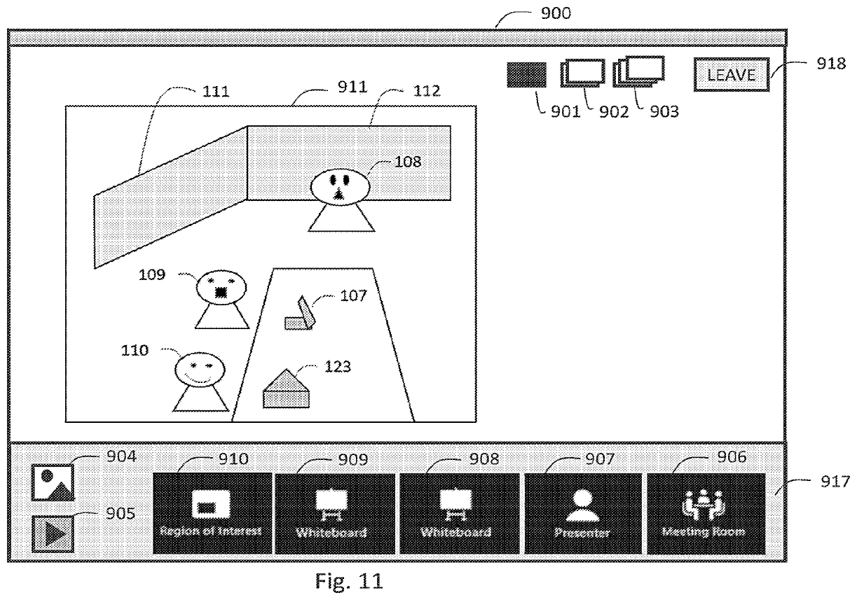

The client computer 106 may be able to display the online meeting window 900 based on the information received in T101-T103. FIG. 11 illustrates the online meeting window 900 of the present exemplary embodiment. As FIG. 11 illustrates, the online meeting window 900 contains a single view indicator 901, a two view indicator 902, a three view indicator 903, an HR (High Resolution) image selector 904, a video selector 905, video icons 906-910, a display region 911 and a leave button 918. The HR image selector 904, the video selector 905 and the video icons 906-910 are located within a menu region 917.

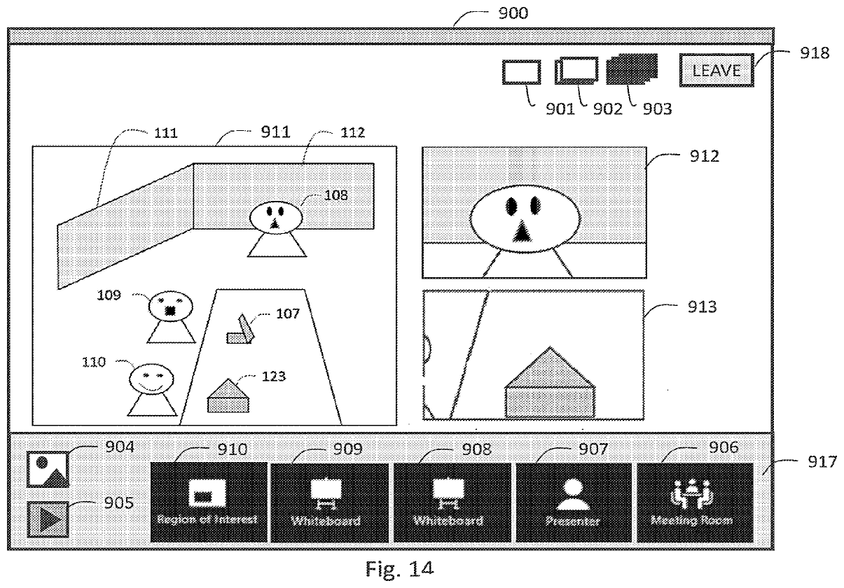

When the single view indicator 901 is selected, the online meeting window 900 may contain the display region 911. In the present exemplary embodiment, if the two view indicator 902 is selected as shown in FIG. 13, the online meeting window 900 may contain two display regions (911 and 912), and if the three view indicator 903 is selected as shown in FIG. 14, the online meeting window 900 may contain three display regions (911, 912 and 913). The user of client computer 106 may be able to choose any indicator from the indicators 901, 902 and 903 to layout the online meeting window 900 based on how many regions the user wants to see in parallel and the size of the display region desired.

Also, the user of the client computer 106 is able to choose one or more icons from among a meeting room icon 906, a presenter icon 907, a whiteboard icon A 908, a whiteboard icon B 909 and an ROI icon 910 as shown in FIG. 11. In the present exemplary embodiment, the choice is performed by a drag-and-drop operation on the icon from the menu region 917 to the display regions 911, 912 or 913 respectively. FIG. 13 illustrates the online meeting window 900 when the meeting room icon 906 has been dropped into the display region 911 and the presenter icon 90 has been dropped into the display region 912.

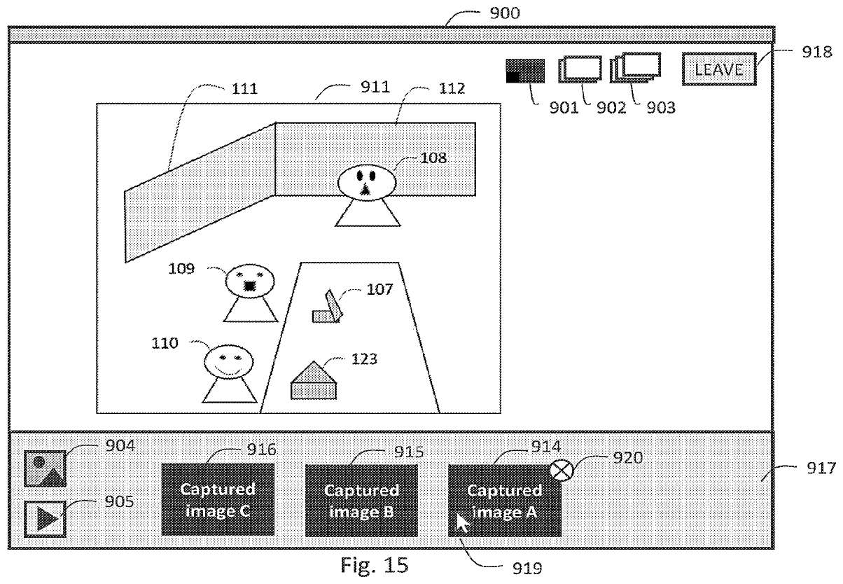

FIG. 11 illustrates a state where the HR image selector 904 is disabled, the video selector 905 is enabled and the video icons 906-910 are displayed on the menu region 917. On the other hand, FIG. 15 illustrates a state where the HR image selector 904 is enabled, the video selector 905 is disabled and the HR image icons 914-916 are displayed on the menu region 917. That is, a user can click or tap on either of the HR image selector 904 and the video selector 905 to switch the icons to be displayed on the menu region 917 between the video icons 906-910 and the HR image icons 914-916. The images corresponding to the HR image icons 914-916 are high resolution images which are obtained by capturing with an optical zoom control of the camera 101. According to the switching mechanism using the HR image selector 904 and the video selector 905, it may be easier for users to choose a desired icon even if many HR still images are generated.

In the present exemplary embodiment, a display order of the video icons 906-910 within the menu region 917 is determined based on a generation order of each media stream. For example, if the video 113 of the meeting room 101 is firstly defined among the all videos provided from the control apparatus 103 to the client computer 106, the meeting room icon 906 corresponding to the video 113 is located at the right most within the menu region 917. Similarly, in the present exemplary embodiment, FIG. 11 illustrates the online meeting window 900 when the presenter region corresponding to the presenter icon 907 is secondly defined/designated and the whiteboard region A corresponding to the whiteboard icon A 908 is thirdly defined/designated among the regions in the captured video. The generation order of the video streams is represented by ID 401 of the name and position information 120 explained with reference to FIG. 4.

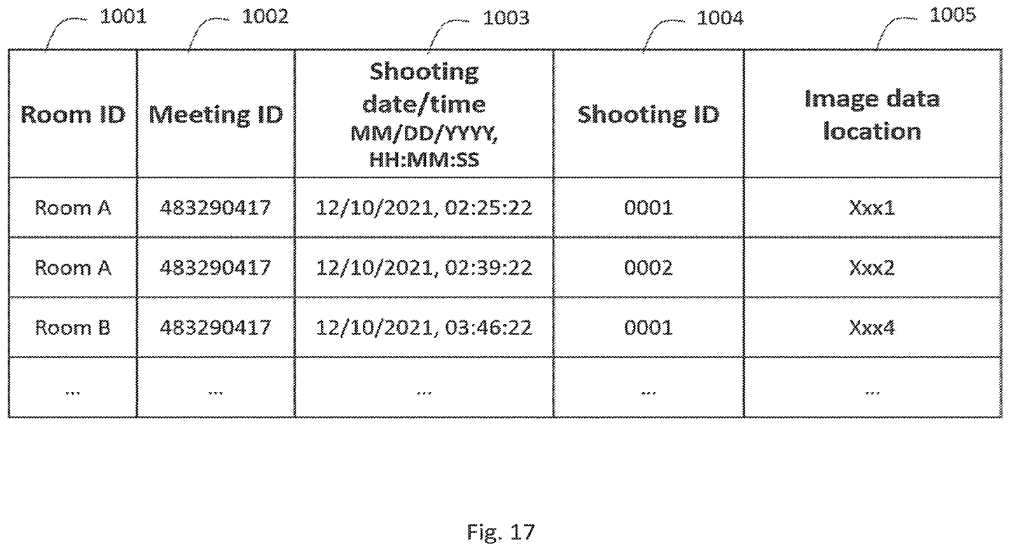

In the present exemplary embodiment, the display order of the HR images within the menu region 917 is also determined based on a generation order of each HR image. In other words, as shown in FIG. 15, the HR image icon 914 corresponding to a high resolution still image (Captured image A) captured earlier than the other high resolution still images (Captured images B and C) is displayed at the right most position within the menu region 917. The generation order information is provided by the control apparatus 103 to the client computer 106 in S105. FIG. 17 illustrates HR image information in the present exemplary embodiment. The HR image information contains a Room ID 1001, a Meeting ID 1002, a Shooting date/time 1003, a Shooting ID and an Image data location 1005. The client computer 106 may identify the generation order of the HR still images based on the shooting date/time 1003 to determine the display order of the HR image icons within the menu region 917. However, this is not seen to be limiting. For example, the display order of the HR image icons may be determined based on the Room ID 1001 and/or the Meeting ID 1002. As another example, the client computer 106 may determine the display order of the HR image icons such that the HR image icon corresponding to the oldest HR image is located at the left most position within the menu region 917 and the HR image icon corresponding to the second oldest HR image is located at the second from the left within the menu region 917.

Note that the client computer 106 may be able to remove any of the icons 906-910 and 914-916 as per user operations. In the present exemplary embodiment, when a mouse cursor 919 moves onto an arbitrary icon (e.g. icon 914), a removal button 920 for a remove instruction is displayed, as shown in FIG. 15. If the user clicks or taps on the removal button 920, the corresponding icon may be removed from the online meeting window 900.

FIG. 11 illustrates the online meeting window 900 with a case where one meeting room 101 is connected to the control apparatus 103. However, two or more meeting rooms may be able to connect to via respective control apparatus 103 that each connect to servers thereby granting access to one of the meeting rooms to the other of the meeting rooms. If two meeting rooms are connected, two meeting room icons may be displayed on the menu region 917, and name and position information with reference to FIG. 4 may contain name and position information for the second meeting room.

Returning to FIG. 18, in T104, the client computer 106 identifies one or more videos/images to be displayed on the online meeting window 900. As described above, a user is able to instruct based on the drug-and-drop operations on the online meeting window 900, and the number of videos/images which can be displayed on the window 900 is depending on which of the indicators 901, 902 and 903 is selected.

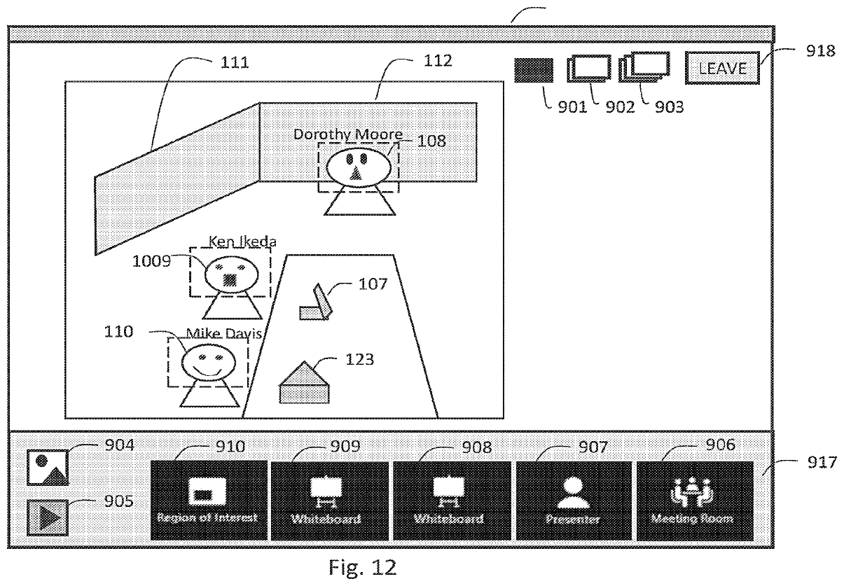

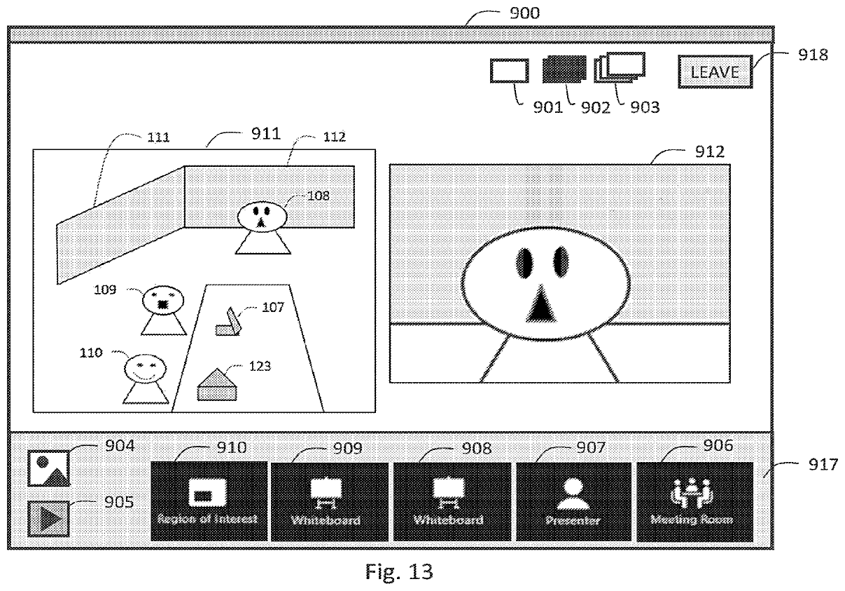

In T105, the client computer 106 determines whether to display username/position on the online meeting window 900. FIG. 12 illustrates the online meeting window 900 which contains the usernames and the position of each face region while FIG. 11 illustrates an example of the online meeting window 900 which does not contain the usernames and position information. The user of the client computer 106 may switch between a state to display the username/position and a state not to display the username/position. If the user instructs to display the username/position, the client computer 106 refers the name and position information 120 received in T102 from the control apparatus 103 to obtain the usernames and positions and superimpose them onto a video displayed within the online meeting window 900.

In T106, the client computer 106 updates display contents on the online meeting window 900 based on the process in T101-T105.

In T107, the client computer 106 determines whether to leave the online meeting. In the present exemplary embodiment, when the user of the client computer 106 clicks or taps the leave button 918 on the online meeting window 900, the client computer 106 determines to leave the online meeting. In addition, the client computer 106 may determine to leave the online meeting when the control apparatus 103 inform the client computer 106 of the meeting is over. If the client computer 106 determines not to leave the online meeting, flow returns to T101-T103. If the client computer 106 determines to leave or over the online meeting, flow proceeds to END.

ROI process described in S108 of FIG. 2 according to an exemplary embodiment will be described in detail below with reference to FIG. 3. S108 may be skipped until a first predefined hand gesture for an ROI designation is detected. If the first predefined hand gesture is detected, flow proceeds to A101.

In A101, the control apparatus 103 determines whether the first predefined hand gesture is being detected for a first predetermined time period (e.g. 2 seconds). In the present exemplary embodiment, the control apparatus 103 detects an open-hand gesture (see FIG. 20C) as the first predefined hand gesture. If the control apparatus 103 determines that the control apparatus 103 continuously detects the first predefined hand gesture for the first predetermined time period, flow proceeds to A102.

In A102, the control apparatus 103 performs a control for output a predetermined sound E for notifying the user that the first predefined hand gesture is detected for the first predetermined time period and it's time to change the hand gesture to a second predefined hand gesture. After outputting the predetermined sound E, flow proceeds to A103.

In A103, the control apparatus 103 determines whether the second predefined hand gesture is detected within a second predetermined time period (e.g. 3 seconds) after outputting the predetermined sound E. In the present exemplary embodiment, the control apparatus 103 detects a closed-hand gesture (see FIG. 20B) as the second predefined hand gesture. If the control apparatus 103 determines that the second predefined hand gesture is detected within a second predetermined time period, flow proceeds to A104.

In A104, the control apparatus 103 determines whether the second predefined hand gesture is being detected for a third predetermined time period (e.g. 2 seconds). If the control apparatus 103 determines that the control apparatus 103 continuously detects the second predefined hand gesture for the third predetermined time period, flow proceeds to A105. When the control apparatus 103 determines “No” in either of A101, A103 and A104, flow proceeds to A111 and the control apparatus 103 determines notifies a user of an error during the ROI designation process.

In A105, the control apparatus 103 performs a control for output a predetermined sound F for notifying the user that the second predefined hand gesture is detected for the third predetermined time period and the ROI designation process is successfully completed. After outputting the predetermined sound F, flow proceeds to A106.

In A106, the control apparatus 103 adds a new media stream according to the ROI designation. More specifically, the control apparatus 103 adds a new media stream 119 to periodically transmit the ROI images cropped from a video frame of the meeting room 101 to the client computers 106 and 107 via the second server 105. If the number of ROIs already designated by the user is larger than a threshold number, the control apparatus 103 may update the oldest ROI position with the new ROI position instead of adding the new media stream.

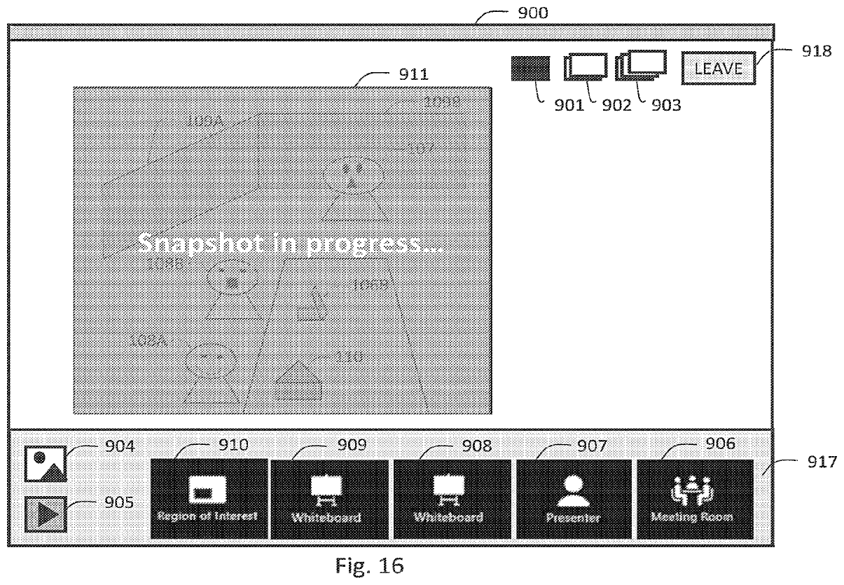

In A107, the control apparatus 103 suspends transmitting video streams 113-116 and transmits image data which includes a message indicating that an ROI capturing is in progress. FIG. 16 illustrates an online meeting window 900 which contains the message and is displayed during an optical zoom magnification control performed in A108.

In A108, the control apparatus 103 controls an optical zoom magnification of the camera 102 according to the ROI position. In an exemplary embodiment, the center of the ROI is identical to the center of the second hand gesture detected in A104, and the dimension of the ROI is 20% of the field of view of the camera 102. For example, if an original captured image is 1280 [pixel]*960 [pixel], the ROI is a 256 [pixel]*192 [pixel] range within the captured image. In A108, the camera 102 performs zoom-in process into the ROI to improve a resolution of the ROI.

In A109, the control apparatus 103 causes the camera 102 to perform capturing process to obtain a HR (High Resolution) still image of the ROI. When the control apparatus 103 obtains the HR still image of the ROI from the camera 102, the control apparatus 103 transmits a URL to the client computers 106 and 107 via the second server 105. The client computers 106 and 107 are able to get the HR still image of the ROI via the second server 105 by accessing the URL. Also, the control apparatus 103 periodically crops the ROI from a video frame of the meeting room 101 and provides the ROI image to the client computers 106 and 107 via the second server 105 unless the ROI detected in A104 is deleted by the user.

In A110, the control apparatus 103 controls an optical zoom magnification of the camera 102 to the original value. In other words, in A110, the optical zoom parameters of the camera 102 returns to parameters before the optical zoom control in A108. After this returning process, the control apparatus 103 resumes transmitting the video streams to the client computers 106 and 107, and flow proceeds to S109 in FIG. 2.

After the ROI designation in S108, the control apparatus 103 periodically crops the ROI within a video frame from the camera 102 and the ROI is provided to the client computers 106 and 107 via the second server 105.

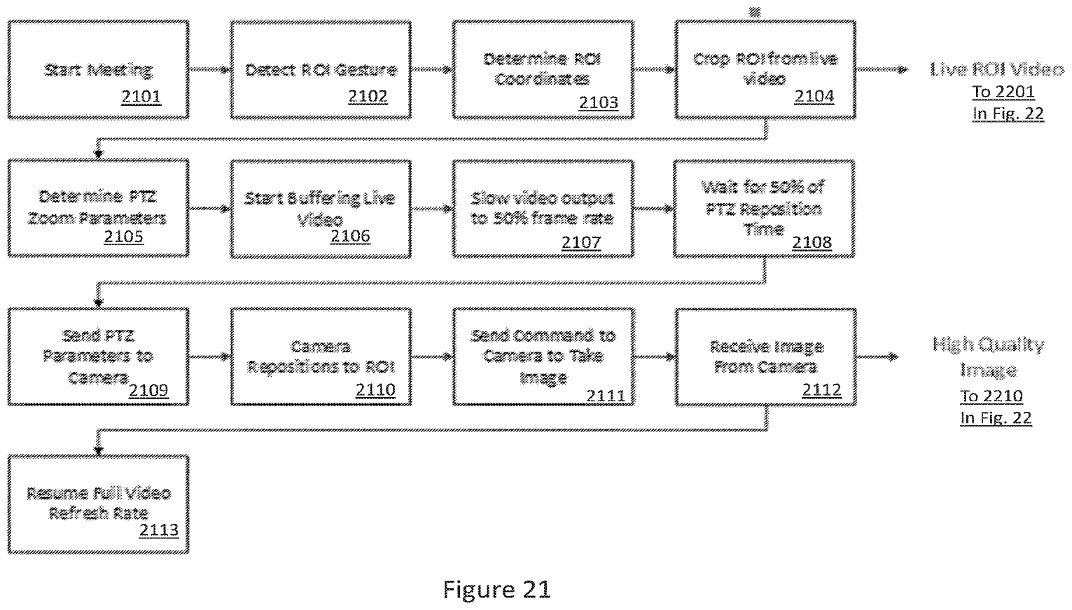

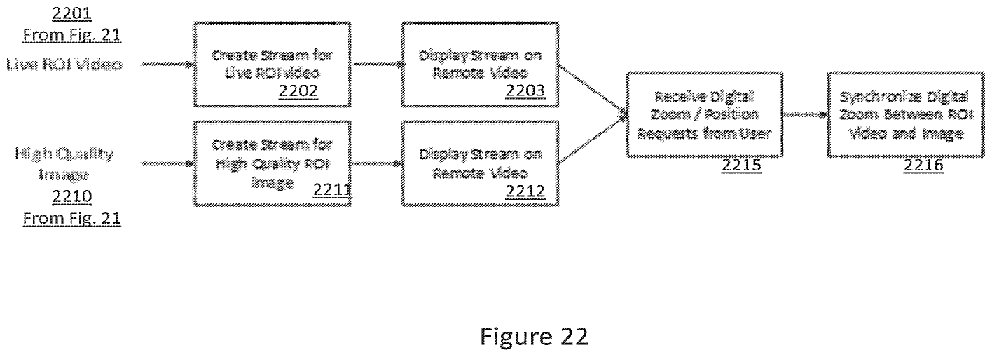

The processing performed in A106-A109 is further described in FIGS. 21 and 22. The processing described therein remedies the drawbacks associated with a hybrid meeting environment where some participants are in-person at a first location (e.g. meeting room) and others are remotely located and are connected to the meeting room using an online collaboration tool. These drawbacks are particularly difficult when a single camera is being used to capture the full meeting room view being transmitted to the remote users. In these environments with single cameras, the camera field of view is often a compromise between obtaining a wide angle to capture the entire view of the room but narrow enough to identify relevant information and people in the room. If the camera is too wide, it is difficult for the remote viewers to identify/review objects within the meeting room. If the view is too narrow, the remote user is unable to view the context of the entire meeting.

The processing performed in A106-A109 advantageously provides a combination view which uses both a digital zoom and capture ROI for live view imaging and static optical zoom and capture for a high quality view of a particular area within the live view captured frame captured using the digital zoom of the image capture device.

In order to take the high quality static image, the system will take over the room camera and pan/zoom to the region-of-interest which is identified in the manner described herein throughout the present disclosure and capture a high-quality image of the identified ROI. Upon completing the capture, the camera will be controlled to return back to the room view position as defined immediately preceding the static image capture. In doing so, a reposition time value is determined that represents a length of time required to reposition the camera (e.g. X seconds) is and a buffering process that buffers the live video is started. The output frame rate of the live video is reduced to a predetermined frame rate less than a present frame rate. In one embodiment, the predetermined frame rate is substantially 50% of the normal frame rate. At the expiration of the reposition time value (e.g. X seconds have elapsed), the control apparatus will send a control signal for controlling the PTZ to reposition such that the PTZ camera can optically zoom in and capture a still image of predetermined region in the wide angle view of the room as identified by the detected gesture and take the high quality image. In one embodiment, the high quality image is captured at a maximum resolution of the image capture device. For example, the image may be captured at 4K resolution. The control apparatus will continue sending the buffered video at predetermined frame rate to the remote computing devices while the repositioning of the camera is occurring. When the reposition and reset is complete, normal frame rate video will resume.

The algorithm for generating these dual views using the single camera is shown in FIG. 21. An online meeting is started in 2101 and the control apparatus 103 causes video data to be captured by the camera 102. During the processing of video capturing, the control apparatus 103, in 2102, detects a gesture such as a transition from the gesture in FIG. 20B to FIG. 20C from one or more users indicating that region of interest within a frame is desired. In actual operation, the user positions their hand in front of an object or area in the room that is in the field of view being captured by the camera 102 and performs the predetermined gesture which is detected by the control apparatus 103 from the video data being captured by the camera 102. The manner in which gesture is recognized and causes an ROI to be identified is described throughout this disclosure and is incorporated herein by reference. In response to detecting a predetermined gesture of the one or more users in the meeting room within the frame of video, the control apparatus 103 determines, in 2103, the coordinates of the ROI based on the position of the detected gesture. This process is similarly described herein and is incorporated herein by reference. Upon detecting the coordinates of the identified ROI, the control apparatus 103 digitally crops the ROI in 2104 from the video data based on the determined coordinates. This cropped ROI represents a digital zoom of the ROI and is communicated to the remote users as a live view ROI and provided as 2201 in FIG. 22 described below. It should be noted that the wide angle view of the room being captured full frame by the camera is still also being captured and is caused to be communicated to the remote computing devices as an individual view different from the crop ROI live view. That process is described throughout and need not be repeated here as the presently described algorithm is focusing on the dual capture of live view ROI regions from within a video frame and a still image having a higher image quality than the captured live view ROI.

In an instance when, not only does a user want to present the live view ROI to the remote user but also wants a higher quality view of the particular ROI, the control apparatus 103 can control the camera 102 to capture a still image having an image quality higher than an image quality being captured via the live-view capture. In one embodiment, the gesture indicating that an ROI within a frame should be captured can initiate the still image capture process that follows. In another embodiment, a further gesture may be required to initiate the still image capture of the ROI at the higher image quality and, upon detection thereof in accordance with the manner described herein, still image capture can be initiated.

In response to control by the control apparatus 103 to capture a still image, the control apparatus 103 determines, in 2105, one or more camera control parameters that will be used to physically control the position of the camera to position the camera to capture a still image of the identified ROI. In one embodiment, the one or more camera parameters includes a pan direction, a pan speed, a tilt direction, a tilt speed and an optical zoom amount required to capture a still image of the area within the ROI. The one or more camera parameters are obtained based on the pixel-by-pixel dimensions of the ROI that corresponds to the region sounding a region within the frame that is identified by the detected gesture. The one or more camera parameters further includes a reposition time value that represents an amount of time it will take the camera to move into the correct position and capture the particular ROI as determined by the detected gesture. In one embodiment, the reposition time value can be determined by calculating an X and Y reposition distance which can occur because the position of the camera is known as is the target position representing the ROI. This value is then multiplying by a constant factor representing the relocation time per unit of distance (ie, 1 MS per pixel). The result is the reposition time value that represents the estimated time it would take the camera to reposition to the new location to capture the still image of the ROI.

The control apparatus 103, after calculating the one or more camera parameters, causes the live video data of the ROI being capture during the live view ROI capture processing to be sent to one or more video buffers in 2106. The control apparatus 103 causes the live view ROI video data in the buffer to be output, in 2107, at a frame rate less than a current frame rate at which the live view ROI is being captured. At a point in time substantially equal to half the reposition time value in 2108, the determined one or more camera parameters are provided, in 2109, by the control apparatus 103 to the camera 102 which causes the camera 102 to be controlled to reposition in 2110 based on the one or more camera parameters and communicate an image capture command in 2111 that causes the camera 102 to capture a still image having a higher image quality than the live view ROI video image that is being output by the buffer at the lower frame rate. The control apparatus receives, in 2112, the captured still image having a higher image quality than an individual frame of the live view ROI image and communicates this captured image to the remote computing devices. In embodiment, the still image captured is transmitted in 2210 to the remote computing devices via a communication channel different from the live view ROI video stream. In another embodiment, this still image is stored in a memory that is specific to a particular user or organization that controls the online meeting. After the high resolution still image capture described above, the video capture rate is caused to return to the rate being captured prior to 2107 such that the live view of the meeting room can be captured and provided as described herein

In a further embodiment, shown in FIG. 22, the live view ROI video data 2201 from FIG. 21 is communicated as a data stream 2202 for display in 2203 within a window on a user interface of the remote computing device and is displayed concurrently with the higher resolution still image captured 2210 from FIG. 21 which is shown in a separate different window within the user interface. The high quality image 2210 is provided as a second different data stream in 2211 and displayed in 2212 in a window different from the window used to display in 2203. In this embodiment, the live view ROI image at the lower quality can be synchronized in 2216 with the higher quality still image which is received as a stream whereby the control apparatus continually sends individual higher resolution images captured during ROI still image capture process. In this embodiment, the control apparatus 103 controls the display of two views of the ROI, one is the crop live-view video having a first resolution of the ROI and the second is the still image capture performed by PTZ optical zoom of the ROI which is at a second resolution higher than the first resolution. The optical zoom has the capability of further digital zoom to see additional detail. The synchronization is to allow the live-view ROI to track the digital zoom of the second view. This synchronization can be performed based on the one or more camera parameters that control the camera repositioning to obtain the still image of the ROI. In this instance, the zoom parameters of ROI-1 and the crop of the live view (ROI-2) would be nearly the same and can be mirrored the digital zoom/pan of ROI-1 (still image capture of ROI) and perform the same digital zoom/pan on ROI-2 (live view ROI).

Turning back to FIG. 2 and the whiteboard processing in S109, an exemplary embodiment will be described in detail below with reference to FIG. 5.

In B101, the control apparatus 103 determines whether a whiteboard region is detected. The control apparatus 103 may detect whiteboard regions based on image recognition process and/or based on user operations. A user is able to designate four corners of a whiteboard to designate a whiteboard region. If the control apparatus 103 determines that the whiteboard region is not detected, flow proceeds to S110. If the control apparatus 103 determines that the whiteboard region is detected, flow proceeds to B102.

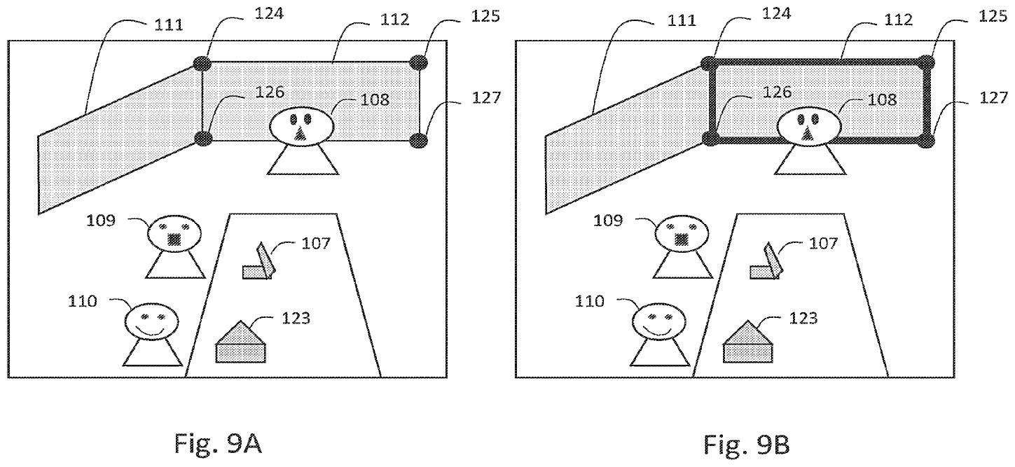

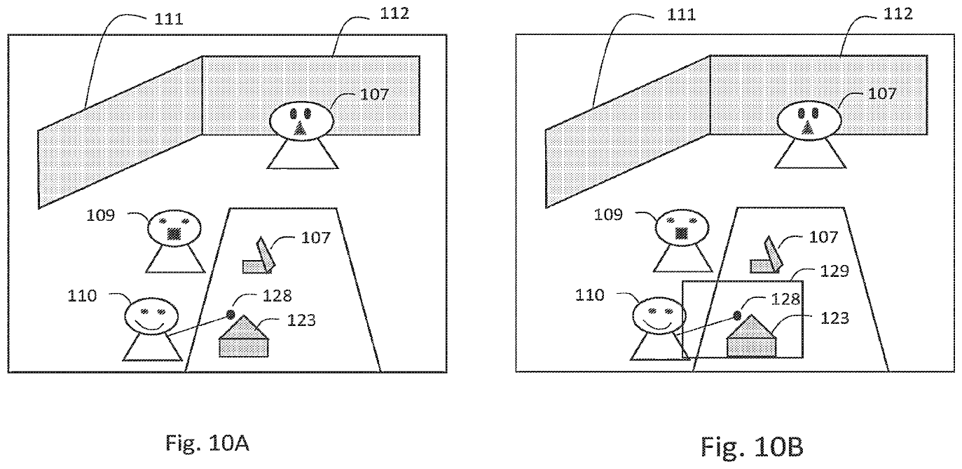

In B102, the control apparatus 103 highlights the whiteboard region thereby a user of the control apparatus 103 is able to see which region is designated as the whiteboard region. FIG. 9A illustrates a state where a user designates the four corners 124, 125, 126 and 127 of a certain whiteboard region 112 in B101, and FIG. 9B illustrates a state where the designated whiteboard region 112 is highlighted in B102. The control apparatus 103 displays these information on a display screen located in the meeting room 101 and the user in the meeting room 101 confirms the whiteboard designation is correctly performed.

In B103, the control apparatus 103 adds a new video stream according to the whiteboard detection. More specifically, the control apparatus 103 adds a new video stream to periodically send the Whiteboard images cropped from a video frame of the meeting room 101 to the client computers 106 and 107 via the second server 105. If the number of whiteboards already detected is larger than a threshold number, the control apparatus 103 may update the oldest whiteboard position with the new whiteboard position instead of adding the new stream.

In B104, the control apparatus 103 performs keystone correction on a video frame of the video of the meeting room 101 and crops the whiteboard region from the keystone corrected video frame to obtain the still image of the whiteboard and the cropped whiteboard region is transmitted to the client computers 106 and 107. As illustrated in FIG. 1, if two or more whiteboard regions are detected, the control apparatus 103 performs the process for the two or more whiteboard regions respectively. Unless the whiteboard region detected in B101 is deleted/released by the user, the control apparatus 103 periodically crops the whiteboard region from a video frame of the meeting room 101 and provides the whiteboard image to the client computers 106 and 107 via the second server 105. In an exemplary embodiment, the control apparatus 103 obtains the whiteboard image without optical zoom control.

The presenter processing of S110 of FIG. 2 according to an exemplary embodiment will be described in detail below with reference to FIG. 6.

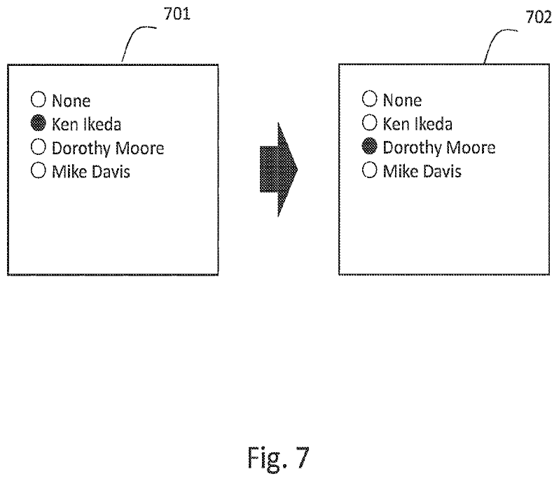

In C101, the control apparatus 103 determines whether the presenter name has been switched after the previous determination. If the control apparatus 103 determines that the presenter name has not been changed, flow proceeds to each of S104-S106. If the control apparatus 103 determines that the presenter name has been changed, flow proceeds to C102. In an exemplary embodiment, the presenter name is able to be switched based on user operations on the control apparatus 103. FIG. 7 illustrates a display region for switching the presenter of the present exemplary embodiment. In this embodiment, the presenter is set as “None” as initial settings, and a display region 701 represents that Ken Ikeda is selected as the presenter, and a display region 702 represents that the presenter is switched from Ken Ikeda to Dorothy Moore.

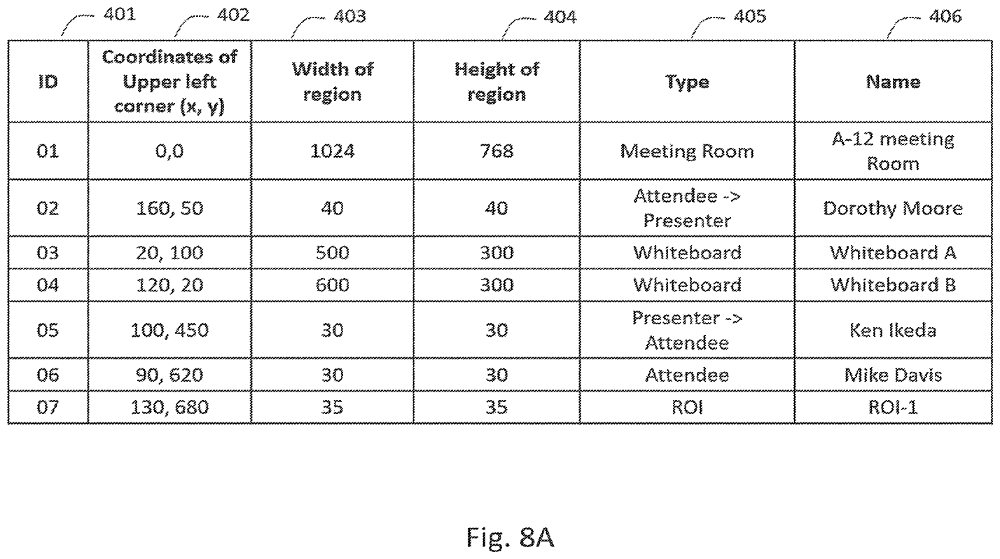

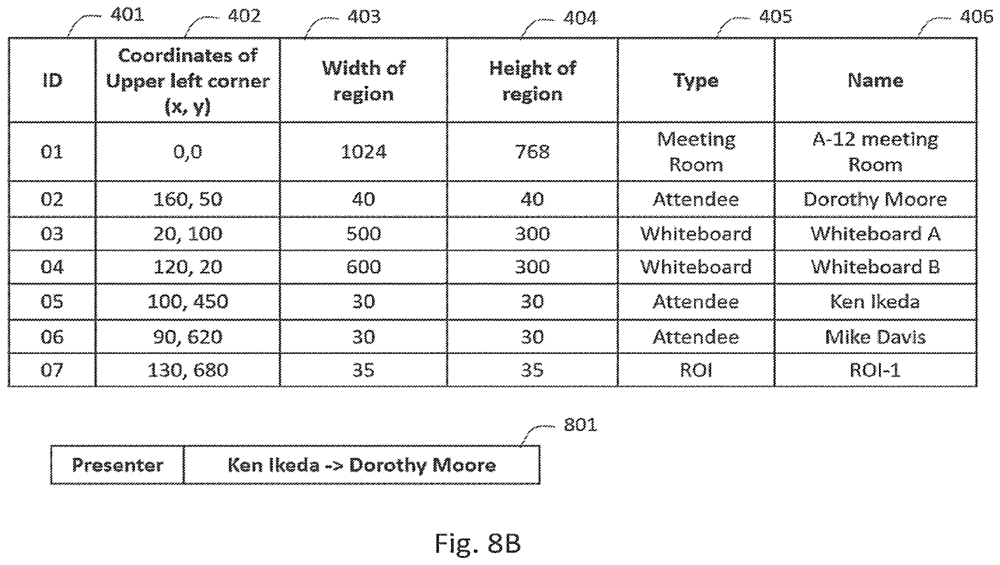

In C102, the control apparatus 103 identifies a username of a current presenter from the name and position information 120 and changes the type 405 of the identified username from “Presenter” to “Attendee”. In an exemplary embodiment as illustrated in FIG. 7, the control apparatus 103 identifies Ken Ikeda as the username of the current presenter and change the Type 405 of Ken Ikeda from “Presenter” to “Attendee”. FIG. 8A illustrates the change of the Type 405 of Ken Ikeda.

In C103, the control apparatus 103 searches for a username of the new presenter from the name and position information as illustrated in FIG. 8A. The control apparatus 103 may find Dorothy Moore as the new presenter and flow proceeds to C104.

In C104, the control apparatus 103 changes the Type 405 of the new presenter Dorothy Moore from “Attendee” to “Presenter”. FIG. 8A illustrates the change of the Type 405 of Dorothy Moore.

In C105, the control apparatus 103 crops the face region of the new presenter from each video frame of the video of the meeting room 101 and transmits the cropped video to the client computers 106 and 107 via the first server 104. Until the presenter is switched, the control apparatus 103 continuously crops the face region of Dorothy Moore from a video frame of the meeting room 101 and provides the cropped video to the client computers 106 and 107 via the first server 104. After C105, flow proceeds to each of S104-S106.

As another exemplary embodiment of C105, the type 405 may not have the type “Presenter” and the control apparatus 103 and the client computers 106 and 107 identify the presenter by referring presenter information 801 that is separately stored from the name and position information 120. FIG. 8B illustrates the name and position information 120 and the presenter information 801 of an exemplary embodiment. As illustrated in FIG. 8B, all human are labeled as “Attendee” at Type 405, and the presenter information 801 is used for identifying the presenter. In this exemplary embodiment, the control apparatus 103 may change the presenter name indicated in the presenter information 801 from Ken Ikeda to Dorothy Moore as illustrated in FIG. 8B.

As described above, the control apparatus 103 may transmit a video of the meeting room 101 and videos of the face regions via the first server 104 and may transmit the images of whiteboards, the images of the ROI and the name and position information via the second server 105. However, this is not seen to be limiting. Another exemplary embodiment, the control apparatus 103 may transmit the video of the meeting room via the first server 104 and may transmit the videos of the face regions, the images of the whiteboards, the images of the ROI and Name and Position information via the second server 105. As another example, the control apparatus 103 may transmit the video of the meeting room, the videos of the face regions and the images of the whiteboards and the images of the ROI cropped from the video frames of the meeting room 101 via the first server 104 and may transmit the images of the HR image of the ROI and Name and Position information via the second server 105.

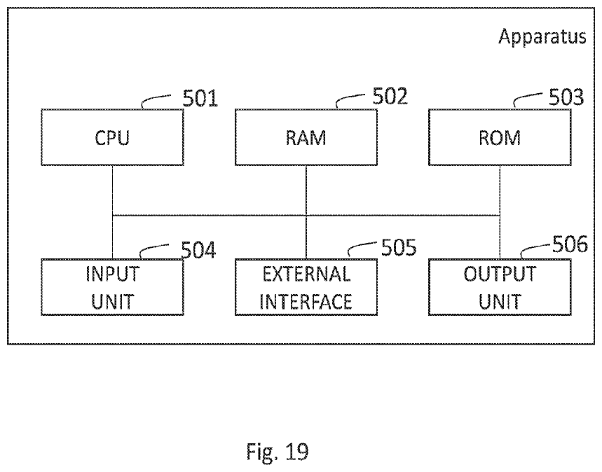

FIG. 19 illustrates the hardware that represents any of the camera 102, the control apparatus 103, the first server 104, the second server 105, the client computers 106/107 and the user recognition service 121 that can be used in implementing the above described disclosure. The apparatus includes a CPU 501, a RAM 502, a ROM 503, an input unit, an external interface, and an output unit. The CPU 501 controls the apparatus by using a computer program (one or more series of stored instructions executable by the CPU 501) and data stored in the RAM 502 or ROM 503. Here, the apparatus may include one or more dedicated hardware or a graphics processing unit (GPU), which is different from the CPU 501, and the GPU or the dedicated hardware may perform a part of the processes by the CPU 501. As an example of the dedicated hardware, there are an application specific integrated circuit (ASIC), a field-programmable gate array (FPGA), and a digital signal processor (DSP), and the like. The RAM 502 temporarily stores the computer program or data read from the ROM 503, data supplied from outside via the external interface, and the like. The ROM 503 stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU 501. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A control apparatus for controlling an online meeting, the apparatus comprising:
one or more processors; and
one or more memories storing instructions that, when executed, configures the one or more processors, to:
receive, from a camera, a captured video of a meeting room;
transmit, via a first server, the captured video to an online meeting client;
specify an ROI (Region Of Interest) from the meeting room;
control an optical zoom of the camera for capturing a still image of the ROI in the meeting room;
transmit, via a second server that is different from the first server processing the captured video of the meeting room, the still image that the camera captures after the control for the optical zoom to the online meeting client.

2. The control apparatus according to claim 1, further configures the one or more processers to:
suspend transmitting the captured video of the meeting room to the online meeting client while the optical zoom control of the camera is performed for capturing the still image of the ROI in the meeting room, and transmit, via the first server, the video including a message indicating that the ROI capturing is in progress.

3. The control apparatus according to claim 2, further configures the one or more processors to:
perform, after the capturing of the still image of the ROI, return process for returning an optical zoom parameter of the camera set before specifying the ROI, and
resume, after the return process, the transmitting the video of the meeting room to the online meeting client.

4. The control apparatus according to claim 1, further configures the one or more processors to:
specify a whiteboard region that is different from the ROI from the captured video of the meeting room, and
wherein the still image of the specified ROI and a still image of the whiteboard region are transmitted to the online meeting client via the second server.

5. The control apparatus according to claim 4, wherein the still image of the whiteboard region is obtained by cropping process on a video frame constituting of the captured video of the meeting room captured without the optical zoom control.

6. The control apparatus according to claim 5, wherein the still image of the whiteboard region is obtained by performing keystone correction process on the captured video of the meeting room.

7. The control apparatus according to claim 1, wherein a URL for downloading the still image of the ROI is transmitted to the online meeting client via the second server according to obtainment of the still image of the ROI, and the still image of the ROI is provided to the online meeting client in response to access the URL by the online meeting client.

8. The control apparatus according to claim 1, further configures the one or more processors to:
detect one or more face regions from the captured video of the meeting room, and wherein each of the one or more face regions is transmitted to the online meeting client via the first server as a video stream other than the captured video of the meeting room.

9. The control apparatus according to claim 8, wherein transmitting the captured video of the meeting room and videos of the one or more face regions to the online meeting client are suspended while the optical zoom control of the camera is performed for capturing the still image of the ROI in the meeting room.

10. The control apparatus according to claim 1, wherein communication with the first server is performed based on a first communication protocol on which a bit rate of a media content is changed according to an available bandwidth of a communication path, and communication with the second server is performed based on a second communication protocol on which a bit rate of a media content is not changed according to an available bandwidth of a communication path.

11. The control apparatus according to claim 10, wherein the first communication protocol is WebRTC, and the second communication protocol is HTTP.

12. The control apparatus according to claim 1, wherein a position of the ROI is determined based on a position of a hand gesture detected from the captured video.

13. The control apparatus according to claim 12, a hand gesture detection process comprises:
detecting a first hand gesture;
outputting a first indicator after passing a first predetermined time from the detection of the first hand gesture;
detecting a second hand gesture within a second predetermined time from outputting the first sound; and
outputting a second indicator after passing a third predetermined time from the detection of the second hand gesture;
wherein the position of the ROI is determined based on a position of the second hand gesture at a timing of the outputting the second sound.

14. A control method for controlling an online meeting, the method comprising:
receiving, from a camera, a captured video of the meeting room;
transmitting, via a first server, the captured video of the meeting room to an online meeting client;
specifying an ROI (Region Of Interest) in the meeting room;
controlling an optical zoom of the camera to capture a still image of the ROI in the meeting room; and
transmitting, via a second server that is different from the first server processing the captured video of the meeting room, the still image that the camera captures after the control for the optical zoom to the online meeting client.

15. A control method for controlling an online meeting, the method comprising:
receiving, from a control apparatus, via a first server, a captured video of the meeting room that is captured by a camera;
receiving, from the control apparatus, via a second server that is different from the first server processing the captured video of the meeting room, a still image that the camera captures after an optical zoom control performed in response to a ROI designation at the control apparatus; and
controlling a display screen to display the captured video and the still image.
